(19) United States
(12) Patent Application Publication
(10) Pub. No.: US 2021/0212423 A1
(43) Pub. Date: Jul. 15, 2021

(54) LUCKY COIN-BASED TOKEN

(71) Applicant: Bentz Luxury, Inc., San Jose, CA (US)

(72) Inventors: Melissa Bentz, San Jose, CA (US); Kimberly Jankowsky, San Jose, CA (US)

(21) Appl. No.: 17/142,414

(22) Filed: Jan. 6, 2021

Related U.S. Application Data
(60) Provisional application No. 62/959,305, filed on Jan. 10, 2020.

(51) Int. Cl. A44C 25/00; A44C 21/00

(52) U.S. Cl. CPC A44C 25/007; G06Q 90/00; A44C 21/00

(57) ABSTRACT

Provided is a lucky token, jewelry or a collector item that includes a magical coin. The coin represents legal tender currency of a member nation of the United Nations and has a native color. The coin is either coated with a material that intentionally and visually alters the native color of the coin, is bejeweled, or both, so as to achieve an aesthetically appealing appearance.

### CROSS-REFERENCE TO RELATED CASES

This case claims priority to U.S. Provisional Patent Application Ser. No. 62/959,305 to Bentz et al., entitled “Lucky Coin-Based Token,” filed Jan. 10, 2020, the disclosure of which is hereby incorporated by reference in its entirety.

### BACKGROUND

The invention relates generally to luxury items in the form of lucky tokens. More specifically, the invention relates to optionally shiny and sparkly coin-based tokens that embody good luck and goodwill, particularly to persons whose believe that magic, luck and goodwill should be spread through the exchange of tangible charms.

There is a saying that holds: “See a penny, pick it up. All day long you'll have good luck.” Consistent with the saying, there exists coins in all cultures that are thought to be associated with good luck as well as with goodwill.

Luck is often created. In some instances, luck represents the fulfilment of a real or imaginary promise. Thus, luck may be equated with a promise, wish, imagination, or hope, e.g., associated with the Make a Wish Foundation (wish.org), which creates life-changing wishes for children.

Luck may be good or bad. For example, a found or gifted heads-side-up penny is generally considered a good luck penny. A stolen penny may bring its thief bad luck.

Coins are issued by governments as legal tender currency. However, the intrinsic worth such coins are associated with magical math that many find charming. For example, under current market conditions, a penny issued by the United States government is worth only $0.01 dollar. However, copper pennies are worth more in metal value than their face value and are worth collecting in large amounts for those interested in investing in penny collections. This is an example of magical math.

With the above considerations in mind, there exist many opportunities to provide a useful, novel and nonobvious lucky token that conforms to wants of the luxury market. The invention described herein represent unique embodiments of such tokens.

### SUMMARY

In a first embodiment, a lucky token is provided. The token comprises a coin that represents legal tender currency of a member nation of the United Nations, typically after the formation of the United Nations as the nation is deemed a voting member thereof. Although the coin has a native color, the coin is coated with a material that visually alters the native color of the coin. For example, the native color may be altered so that the token may appear gold, silver, and/or black. As a result, a sense of magic, luxury and collectability is associated with the token.

The coin may take any number of forms. For example, the coin may be a penny issued by the government of United States of America, a member nation of the United Nations. In such a case, the native color of the coin may be copper or an alloy thereof. In other cases, the native color of the coin may be that nickel, aluminum, iron, titanium nitride, or an alloy/compound thereof. Preferably, the coin represents the lowest denomination of currency for the nation associated with the coin at the relevant time period. The coin may have a minting date in the 1940's after the formation of the United Nations, or in the more recent years, e.g., in the 1960's, 1970's, 1980's, 1990's, 2000's, 2010's, or 2020's. Such coins may be called, pre-millennial, millennial, or post-millennial coins Other lucky coins may, for example, be associated with a European country, e.g., United Kingdom, with a collection of European nations such is the case with Euro coins, or with an Asian country, e.g., China and Japan.

The appearance of the coins/tokens may be beautified by coating the coins with a precious metal such as gold, e.g., 10, 14, 18, or 24 karat gold, silver, platinum, and palladium. When gold or an alloy thereof is used, an aesthetically pleasing hue may be achieved. In some instances, the coins may be coated with a nonnative material that is dark in color such as black for a masculine appearance. Coating compounds may include elements from the same column of the periodic table as Ti, V, Cr, Mn, Fe, Co, Ni, Cu and/or Zn. Further beautification may be achieved by bejeweling the token, e.g., with one or more crystals. Optionally, bejeweling may take place on either face, front or back of the token, and/or about an edge of the token. Further optionally, the token may further comprise a holder immobilized to the coin, wherein the holder may be bejeweled with gems or crystals.

In another embodiment, a lucky token comprising a coin that represents legal tender currency of a member nations of the United Nations, wherein the coin is bejeweled.

In a further embodiment, lucky jewelry or a collector item is comprising a coin the represent legal tender currency of a member nation of the United Nations, the coin having a native color, wherein the coin is coated with a material that visually alters the native color of the coin, and/or the coin is bejeweled. Such jewelry or collector item may take the form of a token, ring, pendant, charm, or bracelet.

Other embodiments of the invention are described herein

### BRIEF DESCRIPTION OF THE DRAWINGS

FIGS. 1A and 1B, collectively referred to as FIG. 1, are an annotated photograph and a line drawing, respectively, that show the “heads” or front face of a lucky token of the invention.

FIGS. 2A and 2B, collectively referred to as FIG. 2, show the “tails” or back face of a lucky token shown in FIG. 1.

FIGS. 3A and 3B, collectively referred to as FIG. 3, show the bejeweled edge of the lucky token of FIGS. 1 and 2.

FIGS. 4A and 4B, collectively referred to as FIG. 4, show an embodiment of the invention in the form of a lucky pendant.

### DETAILED DESCRIPTION OF THE INVENTION

Before describing the present invention in detail, it is to be understood that the invention is not limited to specific luxury items, as such may vary. It is also to be understood that the terminology used herein is for the purpose of describing particular embodiments only, and is not intended to be limiting.

In addition, as used in this specification and the appended claims, the singular article forms “a,” “an,” and “the” include both singular and plural referents unless the context clearly dictates otherwise. Thus, for example, reference to “a token” includes a plurality of tokens as well as a single token, reference to “a crystal” includes a single crystal as well as a combination of crystals, and the like.

Furthermore, terminology indicative or suggestive of a particular spatial relationship between elements of the invention is to be construed in a relative sense rather an absolute sense unless the context of usage clearly dictates to the contrary. For example, the terms “up” and “down” as used to describe the spatial orientation of faces of the inventive token not necessarily indicate that a particular face of the inventive token is located above another particular face.

In this specification and in the claims that follow, reference will be made to a number of terms that shall be defined to have the following meanings, unless the context in which they are employed clearly indicates otherwise:

The term “array” is used to refer to an ordered series or arrangement of items such as crystals or jewels. Arrays of the invention may be circular, semicircular, rectilinear, etc.

The term “charm” is used in its ordinary sense and generally refers to an item, e.g., a small ornament that may be worn on a necklace of bracelet, that is believed to have magical power and/or that possesses the power or quality of giving delight or arousing admiration.

The term “crystal” is used to refer to a piece of a homogeneous solid substance having a geometrically regular form with symmetrically arranged planar faces. For example, highly transparent glass with a high refractive and/or dispersion index may be used to form beads of crystals. Crystals are typically considered beautiful rather than ugly. Examples of crystals can be found at https://www.swarovski.com. Other examples of crystals may take the form of beads, diamonds, emeralds, rubies, sapphires, amethysts, quartz, etc.

The term “gem” is used in its ordinary sense and refers to a precious or semiprecious stone, especially when cut and polished or engraved.

The term “jewel” and “bejeweled” are used in their ordinary sense and refer to precious stones, typically a single crystal or piece of a hard lustrous or translucent mineral cut into shape with flat facets or smoothed and polished for use as an ornament. Thus, a “bejeweled” item refers to an item that is covered or adorned with jewels.

Jewels and/or gems of the invention may take a single color or a plurality of colors such as the case with rainbows. Exemplary colors include, clear (colorless), pink, red, orange, yellow, green, blue, indigo, violet, etc. The jewels and/or gems of the invention may also have an index or refraction and dispersion similar to that of a diamond or of that of leaded glass.

In addition, different colors may evoke different emotions when the invention provided in in wearable form. For example, clear crystals may evoke hope and associated feelings such as divine connection, wisdom, oneness, healing, unity, guidance, truth, protection, and/or intuition. Pink crystals may evoke devotion, and associated qualities such as love, friendship, compassion, honesty, romance, health, generosity, kindness and/or faith. Vermilion crystals may evoke red qualities such as passion, excitement, sensuality, power, courage, positivity, vitality, strength and/or leadership. Blaze orange crystals may evoke happiness, energy, pleasure, adventure, fun, security, strength, enthusiasm, and/or optimism. Radiant topaz yellow crystals may evoke personal power, cheer, wisdom, new beginnings, clarity, enthusiasm, new awakenings, intelligence, and/or spiritual enlightenment. Evergreen or fern green crystals may evoke healing energy, deep commitment, love, abundance, gentleness, tranquility, calmness, personal growth, and/or patience. Skyla sapphire blue crystals may evoke justice, trust, empathy, loyalty, calmness, growth, willpower, peacefulness, and/or devotion. Royalty iris violet crystals may evoke liberality, empathy, loyalty, intuition, compassion, vision, psychic ability, spirituality, and/or openness. When the colors are combined into an iridescent rainbow collection of crystals, promise is signified, with emphasis on hope, new beginnings, harmony, peace, love, balance, leap of faith, purpose and/or serenity.

The term “legal tender currency” refers to tangible items that represent the expression of money.

The term “lucky” is used in its ordinary sense and refers to having, bringing, or resulting from good luck, a force that brings good fortune.

The term “luxury” refers the state the state of comfort and extravagant living, regardless of whether the state of living is expensive in nature.

The term “native” as in “native color of a coin” refers to the color and/or hue or other innate characteristic of the coin that is associated with the coin's minting. For example, the native color/hue of a dollar coin in US currency minted in the year 2019 is believed to be that of titanium nitride, which is similar to the color/hue of gold. As another example, the native color/hue of a penny coin in US currency minted in the year 2019 is believed to be that of electroplated and untarnished copper. Thus, gold is a “nonnative” color of the penny coin of the United States.

The term “promise” is used in its ordinary sense and refers to a declaration or an assurance that one will do a particular thing or that a particular thing will happen.

The term “substantially identical” as used to describe a plurality of items is used to indicate that the items are identical to a considerable degree, but that absolute identicalness is not required. For example, when beads are said to have “substantially identical optical properties,” the beads may appear identical or sufficiently near identical such that any differences in their appearance are trivial in nature, e.g., as is the case for diamonds and cubic zirconia crystal. The terms “substantial” and “substantially” are used analogously in other contexts involve an analogous definition.

The term “token” is used herein refers to a thing serving as a visible and/or tangible representation of a fact, quality, feeling, etc. Tokens may sometimes be exchanged for goods or services, typically one given as a gift or offered as part of a promotional offer.

In general, then, the invention relates to magical tokens formed using coins of national currency. The magical tokens are associated with good luck and good will. The tokens of the invention are typically beautiful in nature and may exhibit a color and luster different from the native surface properties of the coins from which they are formed. In some cases, the tokens are described as “lucky pennies.”

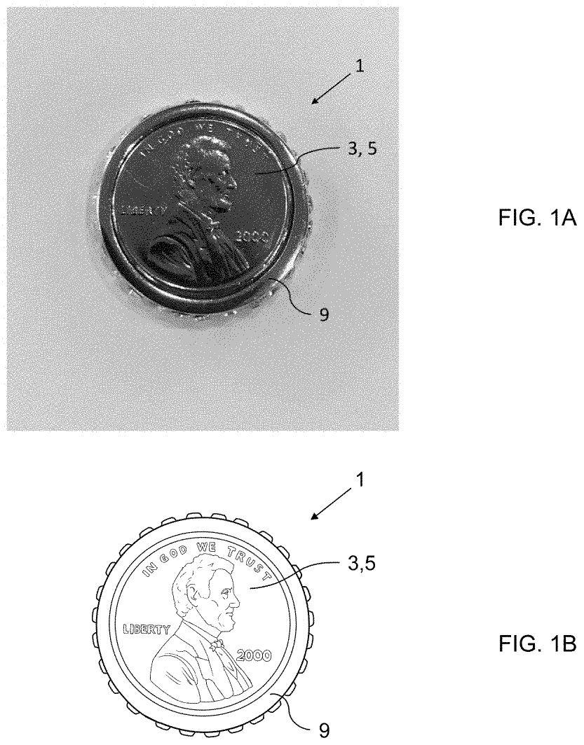

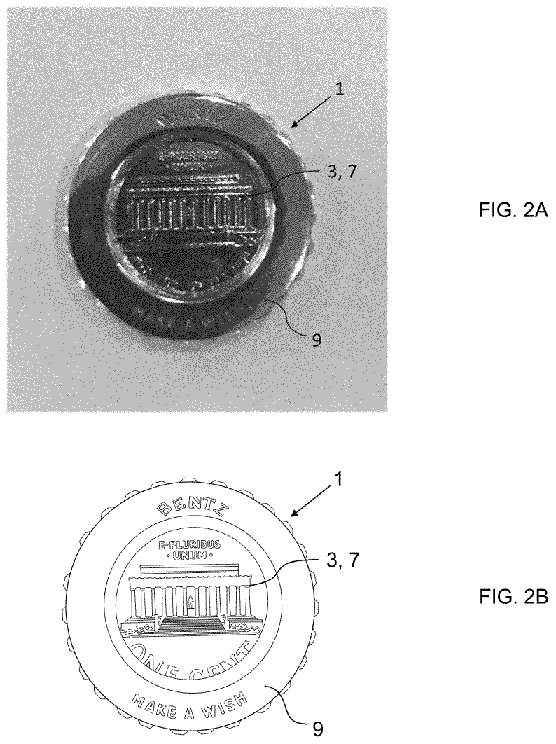

FIGS. 1-3 depicts an exemplary token of the invention. As shown, a token 1, is formed from a coin 3 in the form of a penny, which represents legal tender currency of the United States of America. The penny is of a minting date after the founding of the United Nations. FIG. 1 shows the front face 5 (or heads side) of the token 1. FIG. 2 shows the back face 7 (or tails side) of the token 1.

Token 1 is formed by immobilizing penny 3 relative to holder 9, which forms a bezel about the penny 3. Holder 9 may be formed from any number of materials. Typically, holder 9 is metallic in nature and may be rendered electrically conductive relative to the pendant for processing steps, such as electroplating, evaporation, sputtering, or other ionic and/or vapor deposition of a metal thereon. Depending the particular processing step used in forming token 1, the coin 3 and the holder 9 may have the same or different color and/or luster.

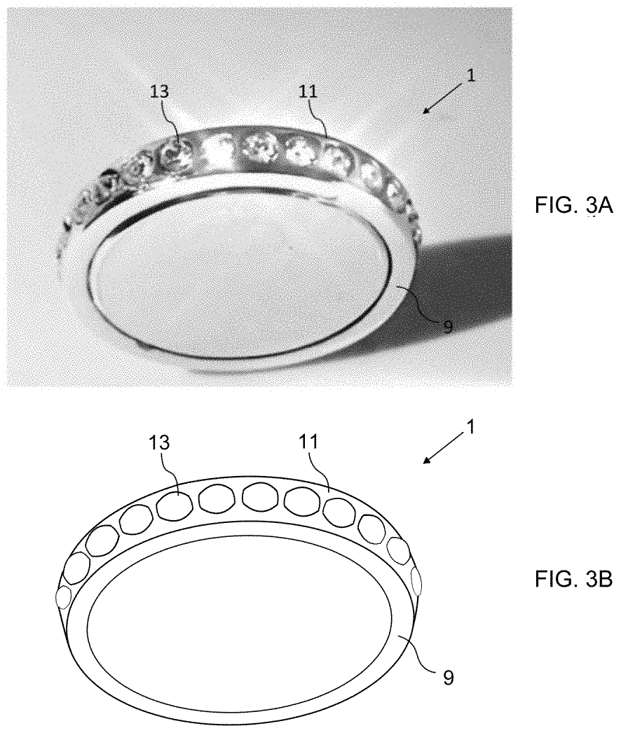

FIG. 3 shows the edge 11 of the token 1. The edge 11 is encrusted with a circular array of gems 13 in the form of Swarovski® crystals, though other types of crystals and/or gems may be used. As shown, the gems 13 are substantially identical in shape, form, and composition, but such identical properties are necessarily required. Typically, the gems are arranged in a manner so as to enhance the beauty and luxuriousness of the token 1.

As shown, the entirety of the first face of the coin, i.e., the “heads” side of the coin is exposed. The center of the second face of the coin, i.e., the “tails” side of the coin is exposed. Thus, the heads side is exposed to a greater degree than the tails side of the coin. The holder has an outer diameter greater than that of the penny. That is, the outer diameter of the holder is about 2.1 cm to about 3 cm and an inner diameter of about 1.6 cm to about 0.1 cm.

In some instances, the front (heads) side of the coin may be entirely exposed, and the back (tails) side of the coin may be entirely covered by the holder 9. In such a case, the part of the holder closest to the back side of the coin may be bejeweled, e.g., with a single gem or crystal at the center of the holder's back surface. Optionally, text or other engraving may be present at the back surface of the holder.

The following is a description of the process in which the token shown in FIGS. 1-3 are made.

First, a clean coin 3 in the form of a penny is provided. Then, the penny is immobilized in the holder 9 in such a way so as to facilitate the deposition of gold or a gold alloy, e.g., 18 karat gold, or other precious metal thereon. In some embodiments, deposition of metal may be carried out via electroplating. In such a case, the coin 3 and the holder 9 may be rendered electrically conductive relative to each other during the immobilization step, e.g., via soldering or some other type of metal-to-metal binding. In other embodiments, deposition may be carried out using vapor deposition. In such a case, the coin and the holder do not have to be rendered electrically conductive relative to each other.

In a variant embodiment, the coin 3 and the holder 9 may be of different surface materials. As a result, the token may exhibit a plurality of different colors.

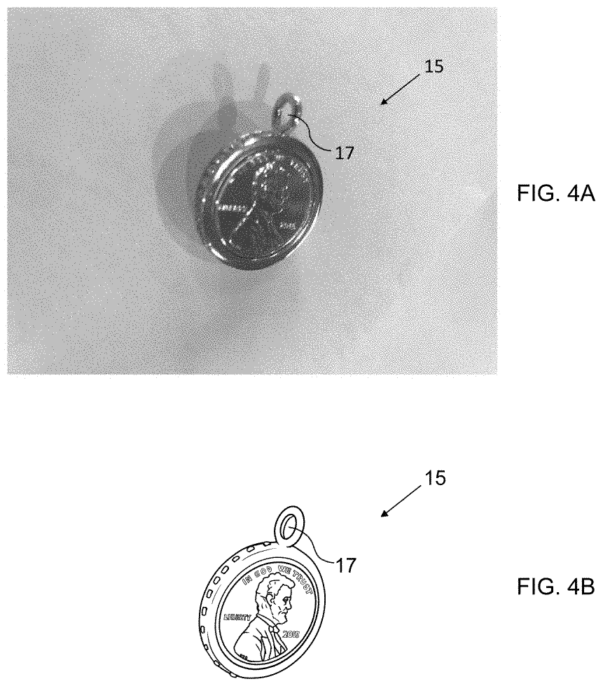

FIG. 4 depicts a pendant 15 of the invention using a process similar to that described above. As shown, the pendant includes a loop 17 through which a chain or string may extend so as to allow a user to wear the pendant as a necklace.

Thus, tokens or like items such as jewelry and other collector items produced that exhibit stunningly beauty, e.g., via proper lighting in a presentation or gift box. Survey results demonstrate that those who have not previously seen the inventive token universally agree that the inventive token is considered stunningly beautiful and worthy of being coveted.

Variations of the present invention will be apparent to those of ordinary skill in the art in view of the disclosure contained herein. For example, the invention may be constructed to contain or exclude specific features according to the intended use of the invention. In some cases, the invention may be free from visible solder and/or welding marks. In addition, the coin and/or holder may be engraved to set forth a message of good will, luck, and fortune. The invention may also serve as a talisman of spirituality and faith, as the lucky penny form of the invention may exhibit the words “In God We Trust.”

A video of various embodiments of the invention can be found at https://youtu.be/UFrW_g33jTU.

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. For example, any particular embodiment of the invention, e.g., those depicted in any drawing herein, may be modified to include or exclude features of other embodiments. Wearable items of apparel such as belts, purses, backpacks, suitcases, and the like are too envisioned by the inventors to accompany the physical manifestations of the invention. That is, the invention may include beautified coin tokens in physical contact or proximity of leather goods, such as purses and crystal straps/belts. The different variations of the invention may come with different story books associated therewith. Alternatively, one story book may be provided with each token. Other aspects, advantages, and modifications within the scope of the invention will be apparent to those skilled in the art to which the invention pertains.

We claim:

1. A lucky token, comprising:
a coin that embodies legal tender currency of a member nation of the United Nations, the coin having a native color, wherein the coin is coated with a material that intentionally and visually alters in an aesthetically pleasing manner the native color of the coin, thereby providing a sense of magic, luxury and/or promise.

2. The token of claim 1, wherein the coin is a penny.

3. The token of claim 1, wherein the member nation is the United States of America.

4. The token of claim 1, wherein native color is that of copper or an alloy thereof.

5. The token of claim 1, wherein the native color is that of nickel or an alloy thereof.

6. The token of claim 1, wherein the native color is that of aluminum or iron or an alloy thereof.

7. The token of claim 1, wherein the native color is that of titanium nitride.

8. The token of claim 1, wherein the material is a precious metal selected from gold, silver, platinum, and palladium.

9. The token of claim 1, bejeweled.

10. The token of claim 9, including one or more crystals.

11. The token of claim 10, wherein a plurality of crystals is included.

12. The token of claim 9, having first and second faces, bejeweled on neither face.

13. The token of claim 9, bejeweled about an edge thereof.

14. The token of claim 1, further comprising a holder immobilized to the coin.

15. The token of claim 14, wherein the holder is bejeweled.

16. A lucky token, comprising:
a coin that represents legal tender currency of a member nation of the United Nations, wherein the coin is bejeweled.

17. Lucky jewelry or a collector item, comprising:
a coin that represents legal tender currency of a member nation of the United Nations, the coin having a native color, wherein
the coin is coated with a material that visually alters the native color of the coin and/or the coin is bejeweled.

18. The jewelry or collector item of claim 17, in the form of a token, ring, pendant, charm, or bracelet.

19. The jewelry or collector item of claim 18, being stunningly beautiful upon initial inspection.

20. The jewelry or collector item of claim 18, wherein the coin is of a minting date after founding of the United Nations.
